(19) United States
(12) Patent Application Publication
(10) Pub. No.: US 2013/0294647 A1
(43) Pub. Date: Nov. 7, 2013

(54) VISUAL MONITORING

(71) Applicant: Shimon Bouganim, Rishon Le'zion (IL)

(72) Inventor: Shimon Bouganim, Rishon Le'zion (IL)

(73) Assignee: ENFORCIVE SYSTEMS LTD, Herzliya (IL)

(21) Appl. No.: 13/875,029

(22) Filed: May 1, 2013

Related U.S. Application Data
(60) Provisional application No. 61/641,341, filed on May 2, 2012.

(51) Int. Cl. G06K 9/62

(52) U.S. Cl. CPC G06K 9/6202
USPC 382/103

(57) ABSTRACT

Systems, methods, and computer program products for monitoring events. For example, a system for monitoring events, may comprise reporting and alerting tools operable to determine one or more values of one or more parameters associated with events, to attempt to match one or more accessible images to the one or more determined values, and to enable display of one or more images which matched the one or more determined values with events.

### CROSS-REFERENCE TO RELATED APPLICATIONS

This application claims the benefit of U.S. Provisional Application No. 61/641,341 filed on 2 May 2012, the disclosure of which is incorporated herein, in its entirety, by this reference.

### TECHNICAL FIELD

The disclosure relates to event monitoring.

### BACKGROUND

Products that monitor system, database and/or security events in computer systems and databases such as IBM mainframe, IBM iSeries, Windows MS Servers, Open Systems, DB2, AS400, Unix, SQL, Oracle, Progress, etc. record these events in the form of event logs. Examples of such products include Security Log management, System Log management, Application Log management, Security Information Management (SIM) and Security Information Event Management (SIEM).

### SUMMARY

In accordance with an aspect of the presently disclosed subject matter, there is provided a system for monitoring events, comprising reporting and alerting tools operable to determine one or more values of one or more parameters associated with events, to attempt to match one or more accessible images to the one or more determined values, and to enable display of one or more images which matched the one or more determined values with events.

In accordance with an embodiment of the presently disclosed subject matter, there is further provided a system, wherein the one or more parameters include user identifier or user name.

In accordance with an embodiment of the presently disclosed subject matter, there is yet further provided a system, wherein for the same user an identical accessible image or a copy thereof corresponds to a plurality of user identifiers or names.

In accordance with an embodiment of the presently disclosed subject matter, there is yet further provided a system, wherein the one or more parameters include platform.

In accordance with an embodiment of the presently disclosed subject matter, there is yet further provided a system, wherein the one or more parameters include application.

In accordance with an embodiment of the presently disclosed subject matter, there is yet further provided a system, wherein the events are security events.

In accordance with an embodiment of the presently disclosed subject matter, there is yet further provided a system, wherein the system is further operable to receive reports of events from one or more systems for Security Log management, System Log management, Application Log management, Security Information Management (SIM) and/or Security Information Event Management.

In accordance with an embodiment of the presently disclosed subject matter, there is yet further provided a system, wherein the system is further operable to generate events.

In accordance with an embodiment of the presently disclosed subject matter, there is yet further provided a system, wherein the system is further operable to filter events by image in order to find events whose parameter values match said image.

In accordance with an embodiment of the presently disclosed subject matter, there is yet further provided a system, wherein the attempt to match is performed for any event arriving at the system.

In accordance with an embodiment of the presently disclosed subject matter, there is yet further provided a system, wherein the attempt to match is performed when a violation event arrives at the system.

In accordance with an embodiment of the presently disclosed subject matter, there is yet further provided a system, further comprising a data repository for storing images corresponding to possible values of one or more parameters associated with events.

In accordance with an aspect of the presently disclosed subject matter, there is yet further provided a method of monitoring events, comprising:
determining one or more values of one or more parameters associated with an event;
attempting to match one or more accessible images to the one or more determined values; and
enabling display of one or more images which matched the one or more determined values when the event is displayed.

In accordance with an embodiment of the presently disclosed subject matter, there is yet further provided a method, wherein the events are security events.

In accordance with an embodiment of the presently disclosed subject matter, there is yet further provided a method, further comprising:
receiving a report of the event from a system for Security Log management, System Log management, Application Log management, Security Information Management (SIM) or Security Information Event Management.

In accordance with an embodiment of the presently disclosed subject matter, there is yet further provided a method, further comprising generating the event.

In accordance with an embodiment of the presently disclosed subject matter, there is yet further provided a method, wherein the attempting to match is performed for any arriving event.

In accordance with an embodiment of the presently disclosed subject matter, there is yet further provided a method, wherein the attempting to match is performed for any arriving violation.

In accordance with an embodiment of the presently disclosed subject matter, there is yet further provided a method, wherein the one or more parameters include user identifier or user name.

In accordance with an embodiment of the presently disclosed subject matter, there is yet further provided a method, wherein for the same user a selected image corresponds to a plurality of user identifiers or names.

In accordance with an embodiment of the presently disclosed subject matter, there is yet further provided a method, wherein the one or more parameters include platform.

In accordance with an embodiment of the presently disclosed subject matter, there is yet further provided a method, wherein the one or more parameters include application.

In accordance with an aspect of the presently disclosed subject matter, there is yet further provided a method of monitoring events, comprising:
receiving a selection of one or more images; and
filtering accessible events in order to determine which events are associated with one or more values of one or more parameters matching said one or more images.

In accordance with an embodiment of the presently disclosed subject matter, there is yet further provided a method, wherein the one or more parameters include user identifier or user name.

In accordance with an embodiment of the presently disclosed subject matter, there is yet further provided a method, wherein for the same user a selected image corresponds to a plurality of user identifiers or names.

In accordance with an embodiment of the presently disclosed subject matter, there is yet further provided a method, wherein the one or more parameters include platform.

In accordance with an embodiment of the presently disclosed subject matter, there is yet further provided a method, wherein the one or more parameters include application.

In accordance with an aspect of the presently disclosed subject matter, there is yet further provided a computer program product comprising a computer useable medium having computer readable program code embodied therein for monitoring events, the computer program product comprising:
computer readable program code for causing the computer to determine one or more values of one or more parameters associated with an event;
computer readable program code for causing the computer to attempt to match one or more accessible images to the one or more determined values; and
computer readable program code for causing the computer to enable display of one or more images which matched the one or more determined values when the event is displayed.

In accordance with an aspect of the presently disclosed subject matter, there is yet further provided a computer program product comprising a computer useable medium having computer readable program code embodied therein for monitoring events, the computer program product comprising:
computer readable program code for causing the computer to receive a selection of one or more images; and
computer readable program code for causing the computer to filter accessible events in order to determine which events are associated with one or more values of one or more parameters matching said one or more images.

### BRIEF DESCRIPTION OF THE DRAWINGS

In order to understand the subject matter and to see how it may be carried out in practice, examples will be described, with reference to the accompanying drawings, in which:

FIG. 1 is a block diagram schematically illustrating one example of a central management system and related systems, in accordance with the presently disclosed subject matter;

FIG. 2 is a flowchart illustrating one example of a method for monitoring events, in accordance with the presently disclosed subject matter;

FIG. 3 is an example of a graphic user interface (GUI) displaying an event, in accordance with the presently disclosed subject matter;

FIG. 4 is another example of a graphic user interface (GUI) displaying an event, in accordance with the presently disclosed subject matter; and

FIG. 5 is another example of a graphic user interface (GUI) displaying an event, in accordance with the presently disclosed subject matter.

### DETAILED DESCRIPTION

Described herein are some examples of visual event monitoring. Typically although not necessarily events are security events.

In the following detailed description, numerous specific details are set forth in order to provide a thorough understanding of the subject matter. However, it will be understood by those skilled in the art that some examples of the subject matter may be practiced without these specific details. In other instances, well-known stages, methods, modules, elements, and systems have not been described in detail so as not to obscure the subject matter.

As used herein, the phrase “for example,” “such as”, “for instance”, e.g., and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one non-limiting example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “receiving”, “filtering”, “monitoring”, “matching”, “attempting”, “selecting”, “reporting”, “displaying”, “storing”, “retrieving”, “accessing” or the like, refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

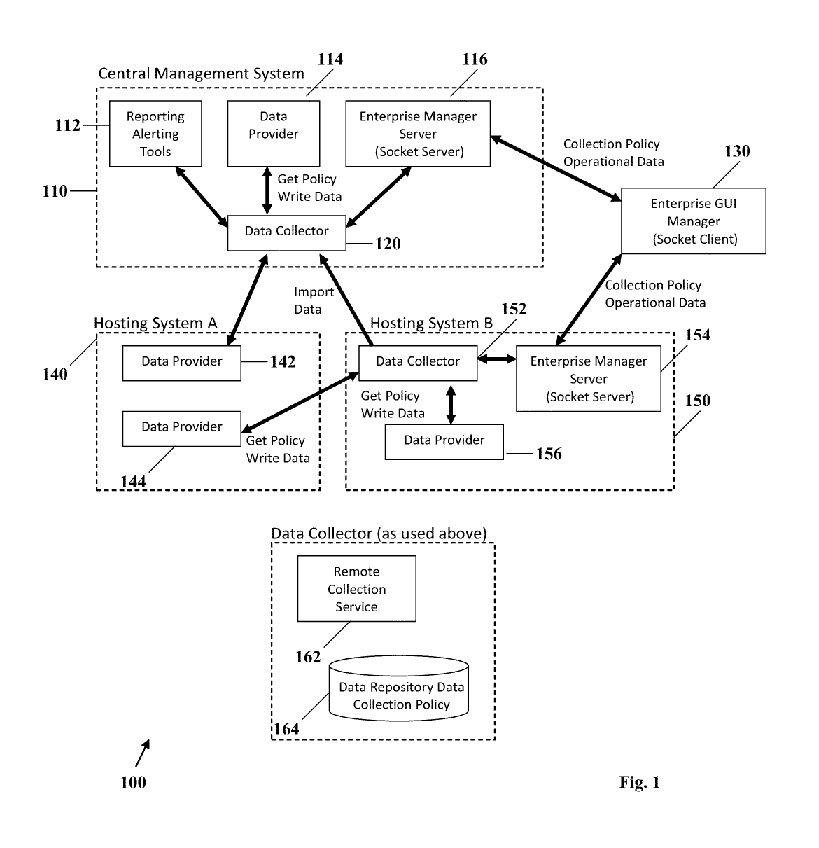

Referring now to the figures in more detail, FIG. 1 is a block diagram schematically illustrating one example of a central management system and related systems, in accordance with the presently disclosed subject matter.

In the illustrated example, the central management system 114 includes reporting and alerting tools 112, a data provider 114, an enterprise manager server 116 and a data collector 120.

In the illustrated example, related systems include an enterprise GUI manager 130, and one or more hosting systems. In the example shown in FIG. 1 hosting system A 140 includes two data providers 142 and 144 and hosting system B includes a data collector 152 a data provider 156 and an enterprise manager server 154.

In the illustrated example, each data collector (e.g. 120, 152) includes a remote collection service 162 and data repository 164. The remote collection service is optional. The data repository 164 includes data collection and extract (filtering) by policies.

In some cases, a data collector (e.g. 120, 152) may also include one or more data collection policy modules. A data collector may be installed separately in different network segments in order to provide network load optimization. When remote collection service 162 is not used, the data collector may still communicate with local data providers.

In some cases, central management system 110 may provide central event management, event data consolidation, reporting and alerting tools as an enterprise security solution. Examples of types of events include successful events, warning events (simulation), reject events. Reject events and warning events are also termed violations. Events may be generated by central management system 110 or reports of events may be received from elsewhere (e.g. listed in event logs recorded by related system(s) for Security Log management, System Log management, Application Log management, Security Information Management (SIM) and/or Security Information Event Management, etc., the logs being received by central management system 110). Central management system 110 may consolidate event data from different system and platforms into one or more databases (e.g. Progress, IBM DB2, SQL server, Oracle, MYSQL, etc.) in data repository 164 associated with central management system 110. Once the data is consolidated, reporting and alerting tools 112 may be used to uncover security breaches. Central management system 110 may also have images of applications (e.g. MS Office, MS Excel, etc.) and platforms (e.g. IBM, Microsoft, AIX, etc.) predefined in the data repository (e.g. in a table for applications or other data structure, table for platforms or other data structure, etc.), and/or images corresponding to users may be imported into the data repository. For instance, if a company maintains computerized images of workers for the purpose of granting access to a building or other resource or for clocking in, central management system 110 may provide an interface that read ID files of workers including the images. The images may be added as a table or other data structure to the company's data within data repository 164 associated with central management system 110. These images may subsequently be matched to events. Images corresponding to users may be cataloged by values of ID's, user names, etc. in central management system 110. If a particular user has more than one value for ID and/or user name, then depending on the instance the identical image (or a copy thereof), or different images of the user may be cataloged for each ID and/or user name value. For instance, a copy of the identical image may appear a number of times in a table or other data structure corresponding to a company's data for different user ID values of the same employee on different platforms. Additionally or alternatively images (e.g. corresponding to applications, platforms, and/or users, etc.) may be otherwise accessible to central management system 110 in addition to or instead of being accessible due to being stored in data repository 164 associated with central management system 110. Central management system 110 may match an event to one or more images associated with the value of the application, platform, and/or user name/ID, etc. corresponding to the event and display the image(s) when displaying the event in a GUI.

In some cases, event related data may be in different formats depending on the source of the data. The event data from different sources may be transformed to a generic data format during a data normalization process (e.g. performed by a data provider) which is a systematic way of ensuring that a database structure is suitable of general purpose querying.

In some cases, an event may be registered in central management system 110.

In some cases, central management system 110 may distinguish and correlate between an event itself, such as an SQL statement, and changes that were made to data repository 164 associated with central management system 110, such as a changed salary filed or a changed amount in a credit card. In these cases, not only would the changes made to the data repository be displayed in an online inquiry via GUI manager 130 but also the field value contents before and after the change would be displayed.

In some cases, a data source may be a collection of events designated for central management system 110. A source system may be the system that includes a data source. A data provider may be a bridge between central management system 110 and a data source. A hosting system may be a system on which a data provider is running An audit policy may be a source system setup that allows registration of event, in other words what data is available for collection. A data collection policy may be a set of attributes/filters that define which information should be collected from a source system, in other words, what data is collected. A data type may be a data structure ID. A data type may be described by system type and application. A single data provider may have access to a data source that includes different applications of a given system type. A component may be a module that is responsible for specific functionality. An interface may be a set of properties and functions that connect components.

In some cases, central management system data collector 120 may import data from other data collector(s) (e.g. 152) and/or communicate directly with data provider(s) (e.g. 114, 142, 144, 156). Alert events may be handled by both local data providers and the remote collection service 162 associated with central management system data collector 120 using an alert or by implementing a trigger on the data repository 164 associated with central management system data collector 120 so that alerts can correlate events from different directions and systems.

In some cases a data provider (e.g. 114, 142, 144, 156) may communicate with data collector(s) (e.g. 120, 152) directly and/or via remote collection service 162.

In some cases enterprise manager 130 may be a socket client application that provides management and operation functionality for different software components.

In some cases enterprise manager server (e.g. 116, 154) may be a socket server that service enterprise manager 130. It may be installed on central management system 110 or source systems and may provide different services depending on where installed.

Any of the modules in FIG. 1 may be made up of any combination of software, hardware and/or firmware that performs the functions as described and explained herein. In some cases, system 110 and/or any of the related systems, or a part thereof may comprise a machine specially constructed for the desired purposes, and/or may comprise a programmable machine selectively activated or reconfigured by specially constructed program code. In some cases, system 110 and/or any of the related systems may include at least some hardware. In various cases, system 110 and/or any of the related systems may be centralized in one location or dispersed over more than one location.

Alternatively to the example shown in FIG. 1, system 110 and/or any of the related systems may in some examples include fewer, more and/or different modules than shown in FIG. 1. Alternatively to the example shown in FIG. 1, the functionality of system 110 and/or any of the related systems may in some examples be divided differently among the modules illustrated in FIG. 1. Alternatively to the example shown in FIG. 1, system 110 and/or any of the related systems may in some examples include additional, less, and/or different functionality.

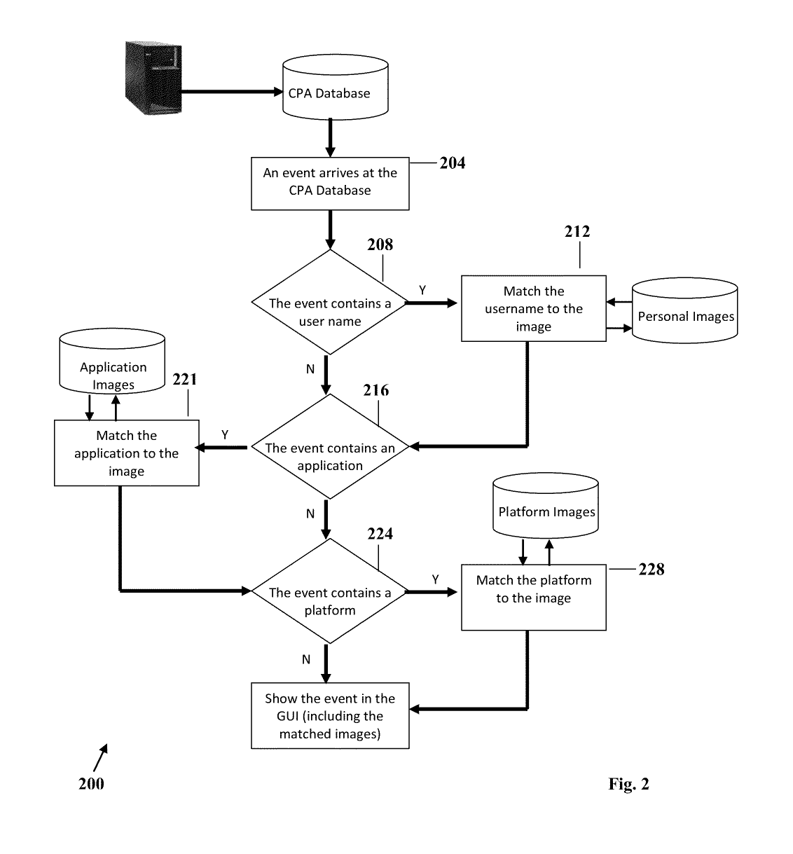

FIG. 2 is a flowchart illustrating one example of a method 200 for monitoring events, in accordance with the presently disclosed subject matter. Central management system 110 may in some cases perform method 200. For simplicity's sake it is assumed in method 200 that any arriving event is displayed. Additionally or alternatively, for simplicity's sake it is assumed that any event may be associated with one or more parameters and that for a particular event the value(s) of parameter(s) (when available) may be attempted to be matched to accessible images. For instance possible parameters may include application, platform, user ID and/or name, etc.

In the illustrated example, in stage 204, an event arrives at data repository 164 of central management system 110. The arriving event may have been generated by central management system 110 or the arriving event may be included in a report received from elsewhere (e.g. Security Log management, System Log management, Application Log management, Security Information Management (SIM) and/or Security Information Event Management system, etc.). In stage 208, central management system 110 (e.g. reporting and alerting tools 112) determines whether or not the event includes a user name/ID value. If yes, then in stage 212 central management system 110 (e.g. reporting and alerting tools 112) attempts to match the user name/ID value to the appropriate accessible image (e.g. from the stored personal images which were previously imported to data repository 164 of central management system).

In the illustrated example, in stage 216 central management system 110 (e.g. reporting and alerting tools 112) determines whether or not the event includes an application value. If yes, then in stage 220 central management system 110 (e.g. reporting and alerting tools 112) attempts to match the application value to the appropriate accessible image (e.g. from the stored application images which were predefined in data repository 164 of central management system 110).

In the illustrated example, in stage 224 central management system 110 (e.g. reporting and alerting tools 112) determines whether or not the event includes a platform value. If yes, then in stage 228 224 central management system 110 (e.g. reporting and alerting tools 112) attempts to match the platform value to the appropriate accessible image (e.g. from the stored platform images which were predefined in data repository 164 of central management system 110).

In the illustrated example, in stage 232, central management system 110 (e.g. reporting and alerting tools 112) enable the displaying of one or more image(s) that were matched in the previous stages of method 200 in a GUI of the event.

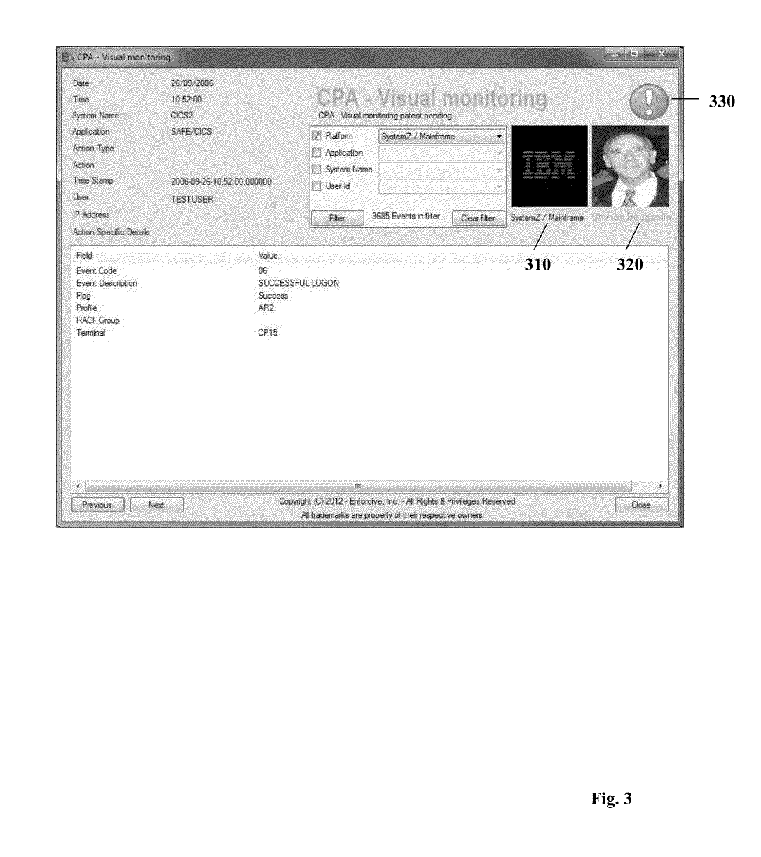

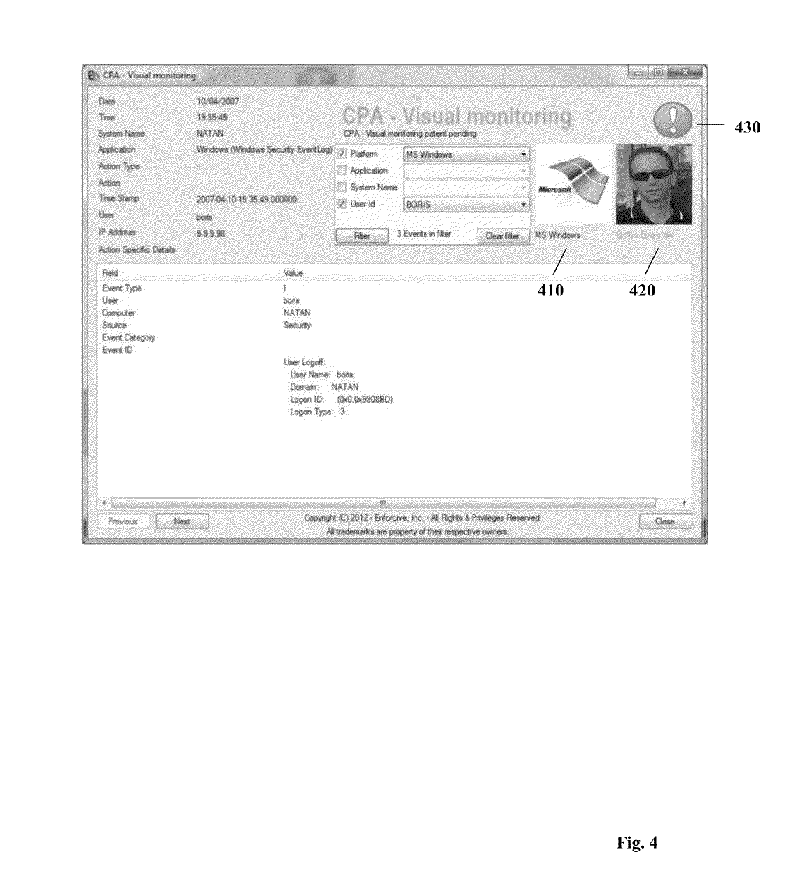

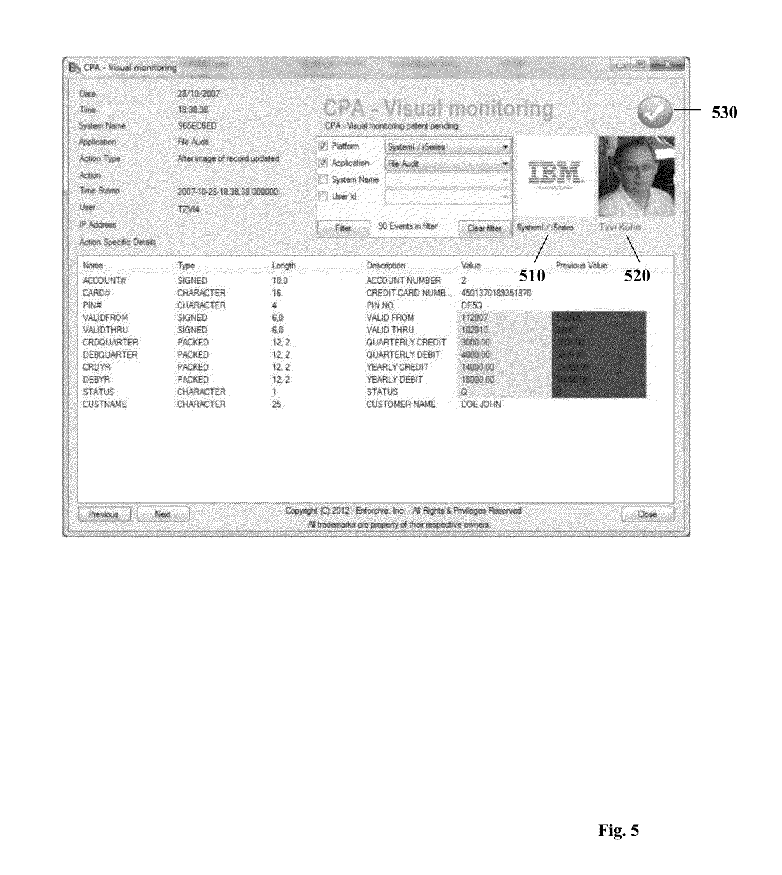

Refer to FIGS. 3, 4, and 5 which are examples of graphic user interfaces displaying an event, in accordance with the presently disclosed subject matter. In FIG. 3 displayed image 310 corresponds to the platform value of the event (SystemZ/mainframe), and image 320 corresponds to the user name value for the event (Shimon Bouganim). In FIG. 4 displayed image 410 corresponds to the platform value of the event (MS Windows), and image 420 corresponds to the user name value for the event (Boris Breslav). Because the application value is unknown for the event displayed in FIGS. 3 and 4, an exclamation mark (330, 430) is displayed rather than an image, but in other examples a different symbol (e.g. generic symbol) or no image may be displayed when no corresponding image is available (e.g. because the application value is unknown and/or because there is no stored or otherwise accessible image matching the application value). In FIG. 5 displayed image 510 corresponds to the platform value of the event (SystemI/iSeries), image 520 corresponds to the user name value for the event (Tzvi Kahn), and image 530 corresponds to the application value for the event (File Audit).

Alternatively to the example shown in FIG. 2, stages which are shown in FIG. 2 as being executed sequentially may in some other examples be executed in parallel and/or stages shown in FIG. 2 as being executed in parallel may in some other examples be executed sequentially. Alternatively to the example shown in FIG. 2 method 200 may in some other examples include more, less and/or different stages than illustrated in FIG. 2. Alternatively to the example shown in FIG. 2, stages may in some other examples be executed in a different order than illustrated in FIG. 2.

It is noted that because the identical image (or a copy thereof) may be associated with different user IDs/names values for the same user, events that are associated with the same user but under different user IDs/names values may be identifiable as being associated with the same user. For instance online filtering of events may be performed by user image, which would result in all events associated with the user image, even if performed under different user IDs/names values.

In some cases, online filtering may be performed by image for user, platform, application, and/or other parameters for which there are or are not images. For instance one or more images may be selected, and accessible events (e.g. stored in data repository 164 of central management system 110 or otherwise accessible) may be filtered in order to determine which events are associated with one or more values of one or more parameters which match the image(s). In these cases, the events determined by the filtering may be displayed in addition to or instead of the display of arriving events as described with reference to FIG. 2.

In some cases, the image of a user attempting an unauthorized operation (e.g. violation such as warning event or reject event, or otherwise sensitive event) may be displayed immediately to a system administrator. In these cases, not all arriving events are necessarily displayed. For instance, only arriving violation events may be displayed.

In some cases, if for an event an image for platform, application, user name, user ID, and/or other parameter may not be displayed (e.g. because the value of the platform, application, user name, user parameter, and/or other parameter is unknown, and/or because no matching image is stored or otherwise accessible), then instead of displaying the image, a generic image may be displayed or no image may be displayed. For instance if an image corresponding to a user name/ID value may not be displayed, a predefined image of a system user may be displayed instead. Depending on the example with a generic image, the same generic image or a different generic image corresponding to a parameter may be displayed for a success, warning or reject event.

In some cases, the display of image(s) for events may help control personnel, administrator(s) and/or auditor(s) make quicker decisions.

It will also be understood that the subject matter contemplates that a system or part of a system disclosed herein may be for example a suitably programmed machine. Likewise, the subject matter contemplates, for example, a computer program being readable by a machine for executing a method or part of a method disclosed herein. Further contemplated by the subject matter, for example, is a machine-readable memory tangibly embodying program code readable by the machine for executing a method or part of a method disclosed herein.

While examples of the subject matter have been shown and described, the subject matter is not thus limited. Numerous modifications, changes and improvements within the scope of the subject matter will now occur to the reader.

1. A system for monitoring events, comprising:
reporting and alerting tools operable to determine one or more values of one or more parameters associated with events, to attempt to match one or more accessible images to said one or more determined values, and to enable display of one or more images which matched said one or more determined values with events.

2. The system of claim 1, wherein said one or more parameters include user identifier or user name.

3. The system of claim 2, wherein for the same user an identical accessible image or a copy thereof corresponds to a plurality of user identifiers or names.

4. The system of claim 1, wherein said one or more parameters include platform.

5. The system of claim 1, wherein said one or more parameters include application.

6. The system of claim 1, wherein said events are security events.

7. The system of claim 1, wherein said system is further operable to receive reports of events from one or more systems for Security Log management, System Log management, Application Log management, Security Information Management (SIM) and/or Security Information Event Management.

8. The system of claim 1, wherein said system is further operable to generate events.

9. The system of claim 1, wherein said system is further operable to filter events by image in order to find events whose parameter values match said image.

10. The system of claim 1, wherein said attempt to match is performed for any event arriving at said system.

11. The system of claim 1, wherein said attempt to match is performed when a violation event arrives at said system.

12. The system of claim 1, further comprising a data repository for storing images corresponding to possible values of one or more parameters associated with events.

13. A method of monitoring events, comprising:
determining one or more values of one or more parameters associated with an event;
attempting to match one or more accessible images to said one or more determined values; and
enabling display of one or more images which matched said one or more determined values when said event is displayed.

14. The method of claim 13, wherein said events are security events.

15. The method of claim 13, further comprising receiving a report of said event from a system for Security Log management, System Log management, Application Log management, Security Information Management (SIM) or Security Information Event Management.

16. The method of claim 13, further comprising generating said event.

17. The method of claim 13, wherein said attempting to match is performed for any arriving event.

18. The method of claim 13, wherein said attempting to match is performed for any arriving violation.

19. The method of claim 13, wherein said one or more parameters include user identifier or user name.

20. The method of claim 19, wherein for the same user a selected image corresponds to a plurality of user identifiers or names.

21. The method of claim 13, wherein said one or more parameters include platform.

22. The method of claim 13, wherein said one or more parameters include application.

23. A method of monitoring events, comprising:
receiving a selection of one or more images; and
filtering accessible events in order to determine which events are associated with one or more values of one or more parameters matching said one or more images.

24. The method of claim 23, wherein said one or more parameters include user identifier or user name.

25. The method of claim 24, wherein for the same user a selected image corresponds to a plurality of user identifiers or names.

26. The method of claim 23, wherein said one or more parameters include platform.

27. The method of claim 23, wherein said one or more parameters include application.

28. A computer program product comprising a computer useable medium having computer readable program code embodied therein for monitoring events, the computer program product comprising:
computer readable program code for causing the computer to determine one or more values of one or more parameters associated with an event;
computer readable program code for causing the computer to attempt to match one or more accessible images to said one or more determined values; and
computer readable program code for causing the computer to enable display of one or more images which matched said one or more determined values when said event is displayed.

29. A computer program product comprising a computer useable medium having computer readable program code embodied therein for monitoring events, the computer program product comprising:
computer readable program code for causing the computer to receive a selection of one or more images; and
computer readable program code for causing the computer to filter accessible events in order to determine which events are associated with one or more values of one or more parameters matching said one or more images.
